(19) United States
(12) Patent Application Publication
(10) Pub. No.: US 2019/0376810 A1
(43) Pub. Date: Dec. 12, 2019

(54) METHODS AND SYSTEMS FOR GENERATING ROUTE INFORMATION IN MAP APPLICATION EXECUTED BY ELECTRONIC DEVICE

(71) Applicant: YANDEX EUROPE AG, Luzern (CH)

(72) Inventors: Petr Vladislavovich PROKHORENKOV, Moscow (RU); Ivan Fedorovich SMIRNOV, Moscow (RU)

(21) Appl. No.: 16/225,448

(22) Filed: Dec. 19, 2018

(30) Foreign Application Priority Data
Jun. 7, 2018 (RU) 2018121140

(51) Int. Cl. G01C 21/36; G01C 21/34; G06Q 10/04; G08G 1/14

(52) U.S. Cl. CPC G01C 21/3685; G08G 1/143; G06Q 10/047; G01C 21/3453

(57) ABSTRACT

There is disclosed a method of generating a parking route. The method is executable by the server and comprises: receiving an indication of a geo-position associated with an electronic device; generating, based on the geo-position, a set of parking candidates; determining a parking-spot-probability at each of the set of parking candidates; generating the parking route containing at least some of the set of parking candidates such as to optimize: a distance to the destination position; total travel time through the parking route; a total parking probability that is based on the parking-spot-probability at each of at least of the set of parking candidates.

### CROSS-REFERENCE

The present application claims priority to Russian Patent Application No. 2018121140, entitled “Methods And Systems For Generating Route Information In Map Application Executed By Electronic Device,” filed Jun. 7, 2018, the entirety of which is incorporated herein by reference.

### FIELD OF TECHNOLOGY

The present technology relates to map applications and, more specifically, to methods and systems for generating route information in map application executed by electronic device.

### BACKGROUND

Many electronic devices available to a user provide geo-location and routing information by means of executing a “map application”.

Some of these electronic devices are dedicated to provision of the geo-location and routing information. An example of such devices would be a portable GPS navigator, such as those available from TomTom Corporation of Amsterdam, The Netherlands. Another example of such devices would be a GPS navigator, built-in into a car. For example, many car manufacturers provide an option to include a built-in navigation system into their cars.

Other electronic devices provide geo-location and route information as an add-on to other functions. For example, most smartphones available on the market today include an application that provides geo-location and routing services. Some of these map applications are “native” to the smartphone, i.e. is provided as part of the operating system or the set of pre-installed applications. Other of such map applications can be downloaded from application repositories (the so-called “app stores”, such as APPLE™ STORE, or the like).

Most of these map applications allow a user to build a “route” from Point A (a starting point) to a Point B (a destination point). Depending on the exact implementation of the map application, the user is also provided with additional choices, such as selection of: a fastest route, a shortest route, a route that avoids highway, a route that avoids toll roads, etc. Once the user provides all the user selections, the map applications generates one or more suggested routes that would take the user from the Point A to the Point B, taking into account the user-selected preferences for the so-generated route.

As the user embarks on driving along the one of the one or more suggested routes, the map application typically displays progress of the user along the route (typically by showing a progression of the user along the route by means of a moving an arrow or another symbol representing the user's position along the suggested route). The map application can also provide the user additional information—such as: time remaining to the destination, any obstacles along the route (such as accidents or constructions sites), traffic information along the route, alternative suggested routes (typically, these are shown is a “less emphasized” manner, such as in a grey color or the like), and the like.

Once the user approaches the destination (i.e. the Point B), the user needs to find a parking spot to leave her vehicle. Depending on the location of the Point B (such as downtown vs suburbs, etc.), finding a parking spot may be a nuisance for the user. The user may waste significant amount of time finding the parking spot. Current implementations of the map application do very little to suggest to the user possible parking spots. The most common solution nowadays is the map application showing, on the displayed map, location of parking garages and the like.

U.S. Pat. No. 9,674,237 (issued on Jun. 6, 2017 to Bostick et al., and assigned to International Business Machines Corporation) disclose method, system, and computer program product for focus coordination in geographically dispersed systems. A shifting of focus to a first object present in a first view is detected at a first data processing system in a first location in the geographically dispersed plurality of data processing systems. Metadata of the first view is identified, the metadata being usable to identify a second object in a second view at a second data processing system in a second location in the geographically dispersed plurality of data processing systems, the second object corresponding to the object in the view. A focus information package is constructed, wherein the focus information package includes an attribute of the first object and the metadata of the first view. The focus information package is sent to the second data processing system.

U.S. Pat. No. 9,470,540 (issued on Oct. 18, 2016 to Castellucci et al., and assigned to International Business Machines Corporation) discloses an approach for locating parking. A computer identifies driving directions to a destination. The computer receives a navigation input from a user to locate parking associated with the destination. The computer calculates one or more navigation paths based on the destination, wherein the one or more navigation paths include one or more street segments that connect identical starting and ending points with at least one different street segment and overall values indicating priority based on one or more weight factors associated with the one or more street segments. The computer selects a first navigation path from the calculated one or more navigation paths utilizing an ordered ranking of the one or more navigation paths. The computer provides driving directions associated with the first navigation path. The computer determines whether the user locates parking while utilizing the first navigation path.

US 2014/0214319 (published on Jul. 31, 2017 to Vucetic et al., and assigned to Parkways, Inc.) discloses a computer system and a method for recommending a driving route that reduces parking search time and parking costs. The system is configured to receive information about a current location of a car, a desired destination, and parking preferences, to process this information together with available traffic and parking information in order to calculate a recommended route a car should follow during a parking search, and to communicate the recommended route to the car driver. The driver is instructed to park at the first available spot along selected portions of the recommended route.

US 2016/0025503 (published on Jan. 28, 2016 to Kees et al., and assigned to Ford Global Technologies LLC.) discloses a final destination for a vehicle that is used to identify a set of parking spaces. One of the parking spaces is selected based at least in part on at least one user parameter and data derived from historical data about the parking spaces. A route to the selected parking space is determined.

### SUMMARY

Embodiments of the present technology have been developed based on developers' appreciation that it is desirable for the map application to generate a “parking route”, as the user's vehicle approaches a final destination of the route generated by the map application.

In accordance with the non-limiting embodiments of the present technology, as the user's vehicle (as approximated by an electronic device's position) approaches the final destination, the map application receives an indication of the position of the electronic device (which can be one or more of the current position of the electronic device and indication of the final destination). The map application then generates a set of parking candidates and calculates a parking route along at least a portion of the parking candidates, the parking route being optimized based on: a distance from the least some of the set of parking candidates to the destination position; total travel time through the parking route; a total parking probability that is based on the parking-spot-probability at each of at least of the set of parking candidates.

Developers of the present technology have developed non-limiting embodiments thereof based on the following premises. What follows is the description of several definitions of the optimization problems, as well as description of computer approaches to implement a computer-executed method for solving such the optimization problem.

The optimization task for the parking route, as contemplated by the embodiments of the present technology can be described as a series of optimization tasks with increased number of optimization constraints and show how the solution can evolve to match the changing optimization problem to solve. In the description to be presented herein below, n will denote a number of parking spaces in involved in the decision making of the system.

In some embodiments of the present technology, it may be required or desirable to determine a parking route, i.e. a parking sequence that visits all parking spaces and has least travel time. The system is developed on an assumption that driving starts from a parking space #0 and go through all other parking spaces in accordance with the parking route. This problem can be categorized as the Hamiltonian path of least weight. In order to generate such the parking route, the system can use a dynamic programming approach. A sub-problem to be defined for such the dynamic programming approach can be: “Find parking sequence that visits a given subset of parking spaces S and ends with given parking space P”. P should be part of S. For the S={0} and P=0, the sequence will be zero and its weight would be zero.

Now, constructing a solution to a sub-problem using a smaller subproblems is. Let's say we have S and P. The last parking space in our sequence is P and the previous one could be any one of S \ {P}. So the optimal solution can be constructed as solution for S \ {P} and X with P appended at the end, where X is in S \ {P}. To put it short:

Solution(S,P)=best out of (Solution(S\{P},X)+[P] for X in S\{P}) Formula 1

It is noted the run-time complexity for finding the answer as the best out of Solution({0 . . . n−1}, k) for kin [0 . . . n−1] is O(2\hat{ }n*\hat{ }2). We system can store the so-calculated answers.

The next problem that can be defined is finding parking sequence that visits at least k parking spaces and has least travel time. The system can analyze all the stored answers to the solution as per Formula 1, and select that answer that is the best answer matching the following requirement: ISI>=k.

Next, the more complex problem can be defined as finding parking sequence that has parking probability not less than p and has least travel time. This more complex problem can be illustrated as follows. As an example, if the two parking spaces have parking probabilities p1 and p2, respectively, and a parking route is generated such that the driver visits them both, then parking probability p is independent of their order. Indeed, it is easy to see that parking probability is equal to

1−(1−p1)*(1−p2) Formula 2

The Formula 2 will have the same value if the values of p1 and p2 were to be swapped. This property of Formula 2 allows for the use of the above-mentioned dynamic programming approach. The system stores parking probabilities for each S.

Finally, the system selects the best solution amongst all values of S and P such that parking probability(S)>=p.

Finally, the problem can be defined as finding a parking sequence that has parking probability not less than p, travel time not greater than t, and has least E(d|parked), where E(d|parked) is an expected value of distance from parking spot (i.e. where the parking actually occurred) to destination conditioned on that the parking even actually occurred.

Within this definition of the problem, it may not be possible to use the dynamic programming approach. This may be due to the fact that each of the S and P has two criteria which the system needs to optimize. Namely, the system needs to optimize both time and E(d|parked). In accordance with the non-limiting embodiments of the present technology, the system addresses this by generating and storing all the Pareto-optimal sequences with the time and E(d|parked) for each S and P.

What this means from the practical system implementation perspective is instead of storing a single best sequence, the system selects all Pareto-optimal ones.

As such, in accordance to a first broad aspect of the present technology, there is provided a method of generating a parking route to a destination position, the parking route to be displayed in a map application, the map application executable by an electronic device. The electronic device is connectable to a server via a communication network. The method can be executable by the server. The method comprises: receiving, from the electronic device, an indication of a geo-position associated with the electronic device; generating, based on the geo-position, a set of parking candidates; determining, by the server, a parking-spot-probability at each of the set of parking candidates; generating, by the server, the parking route containing at least some of the set of parking candidates, the generating being executed to optimize the parking route based on: a distance from the least some of the set of parking candidates to the destination position; total travel time through the parking route; a total parking probability that is based on the parking-spot-probability at each of at least of the set of parking candidates.

In some implementations of the method, the geo-position includes a current position of the electronic device and an indication of the destination position, and the generating the set of parking candidates comprises generating the set of parking candidates such that: each of the set of parking candidates located within a pre-determined radius from at least one of: the current position and the destination position.

In some implementations of the method, the generating the parking route is executed such as to: minimize the distance from a given one of the least some of the set of parking candidates to the destination position, the given one being an actual parking location; minimize the total travel time.

In some implementations of the method, the total travel time is the travel time from the current location to the actual parking location.

In some implementations of the method, the optimizing the parking route comprises applying a Pareto optimality algorithm.

In some implementations of the method, the generating the parking route comprises, for a given one of the set of parking candidates: determining a distance from the current location to the given one of the set of parking candidates; determining a single-state optimization value, the single-state optimization value based on the probability to park at the given one of the set of parking candidates, the single-state optimization value being representative of: the distance from the given one of the set of parking candidates to the destination position; the total travel time through the parking route from the current location to the given one of the set of parking candidates; the total parking probability that is based on the parking-spot-probability at the given one of the set of parking candidates.

In some implementations of the method, the generating the parking route, for the given one of the set of parking candidates, further comprises: determining a two-state optimization value, the two-state optimization value based on the probability to park at a next sequential one following the given one of the set of parking candidates, the two-state optimization value being representative of: the distance from the next sequential one of the set of parking candidates to the destination position; the total travel time through the parking route from the current location to next sequential one; the total parking probability that is based on the parking-spot-probability at the given one of the set of parking candidates and the next sequential one.

In some implementations of the method, the method further comprises repeating the determining step of an N-th-state optimization values using a N-next sequential ones following the next sequential one following the given one of the set of parking candidates.

In some implementations of the method, the method further comprises repeating the determining process for all of the set of parking candidates.

In some implementations of the method, the method further comprises pruning the N-th-state optimization values that have both the total travel time and the distance being under a pre-determined respective threshold value.

In some implementations of the method, the method further comprises: selecting the at least some of the set of parking candidates from the set of parking candidates based on the N-th-state optimization values that are associated with the total parking probability above a pre-determined threshold value.

In some implementations of the method, the selecting the at least some of the set of parking candidates from the set of parking candidates further comprises: based on a minimal value of an average distance to the destination position, the average distance being a contribution to a total distance value of each individual distances of members of a group associated with a particular state of the N-th-state optimization values.

In some implementations of the method, the method further comprises: calculating the total parking probability as a sum of the parking-spot-probability at the given one of the set of parking candidates and the parking-spot-probability at the next sequential one.

In some implementations of the method, the repeating the determining process for all of the set of parking candidates is executed iteratively for all of the set of parking candidates, whereby the iterative process involves starting with a given one and growing a chain of candidates to an N-th length of the at least some of the set of parking candidates.

In some implementations of the method, the method further comprises retrieving the destination position from the map application.

In accordance with another broad aspect of the present technology, there is provided a server configured to generate a parking route, the parking route to be displayed in a map application, the map application executable by an electronic device. The electronic device is connectable to the server via a communication network, the server comprising: a network interface for communication via the communication network; a processor coupled to the network interface. The processor is configured to: receive, from the electronic device, an indication of a geo-position associated with the electronic device; generate, based on the geo-position, a set of parking candidates; determine, by the server, a parking-spot-probability at each of the set of parking candidates; generate, by the server, the parking route containing at least some of the set of parking candidates, the generating being executed to optimize the parking route based on: a distance from the least some of the set of parking candidates to the destination position; total travel time through the parking route; a total parking probability that is based on the parking-spot-probability at each of at least of the set of parking candidates.

In the context of the present specification, a “server” is a computer program that is running on appropriate hardware and is capable of receiving requests (e.g. from client devices) over a network, and carrying out those requests, or causing those requests to be carried out. The hardware may be implemented as one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “electronic device” is any computer hardware that is capable of running software appropriate to the relevant task at hand. In the context of the present specification, the term “electronic device” implies that a device can function as a server for other electronic devices and client devices, however it is not required to be the case with respect to the present technology. Thus, some (non-limiting) examples of electronic devices include personal computers (desktops, laptops, netbooks, etc.), smart phones, and tablets, as well as network equipment such as routers, switches, and gateways. It should be understood that in the present context the fact that the device functions as an electronic device does not mean that it cannot function as a server for other electronic devices. The use of the expression “an electronic device” does not preclude multiple client devices being used in receiving/sending, carrying out or causing to be carried out any task or request, or the consequences of any task or request, or steps of any method described herein.

In the context of the present specification, “client device” is any computer hardware that is capable of running software appropriate to the relevant task at hand. In the context of the present specification, in general the term “client device” is associated with a user of the client device. Thus, some (non-limiting) examples of client devices include personal computers (desktops, laptops, netbooks, etc.), smart phones, and tablets, as well as network equipment such as routers, switches, and gateways It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “software component” is meant to include software (appropriate to a particular hardware context) that is both necessary and sufficient to achieve the specific function(s) being referenced.

In the context of the present specification, the expression “computer information storage media” (also referred to as “storage media”) is intended to include media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage media, including two or more media components of a same type and/or two or more media components of different types.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first database” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware components, in other cases they may be different software and/or hardware components.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

These and other features, aspects and advantages of the present technology will become better understood with regard to the following description, appended claims and accompanying drawings where:

FIG. 1 depicts a schematic diagram of an example computer system for implementing certain embodiments of systems and/or methods of the present technology;

FIG. 2 depicts a networked computing environment being suitable for use with some implementations of the present technology;

FIG. 3 depicts an electronic device of the networked computing environment of FIG. 2 with an output of a map application.

FIG. 4 depicts a signal flow diagram depicting signal flow between the electronic device and a server of networked computing environment of FIG. 2, the signal flow being implemented in accordance with the non-limiting embodiments of the present technology.

FIG. 5 depicts a flow chart of a method of generating a parking route, the method executable by the server in accordance with non-limiting embodiments of the present technology.

FIG. 6 depicts a process for growing the chain of candidates to an N-th length of the at least some of the set of parking candidates.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labelled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application-specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

The System Description

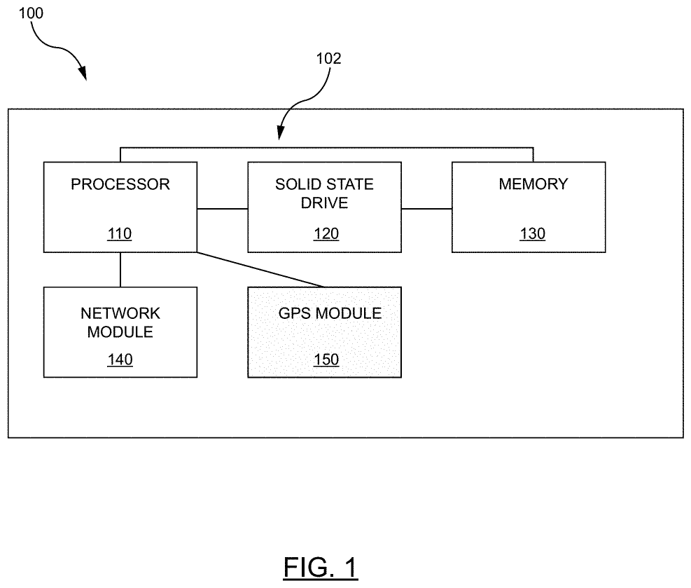

With reference to FIG. 1, there is shown a computer system 100 suitable for use with some implementations of the present technology, the computer system 100 comprising various hardware components including one or more single or multi-core processors collectively represented by a processor 110, a solid-state drive 120, a memory 130, which may be a random-access memory, a network module 140, and a GPS module 150. Communication between the various components of the computer system 100 may be enabled by one or more internal and/or external buses (generally depicted at 102), e.g. a PCI bus, universal serial bus, IEEE 1394 “Firewire” bus, SCSI bus, Serial-ATA bus, etc., to which the various hardware components are electronically coupled. In the non-limiting embodiment depicted in FIG. 1, the communication within the computer system 101 is implemented in a “hub and spoke” manner via the processor 110; however, in alternative implementations of the present technology, the communication can be implemented differently.

According to embodiments of the present technology, the solid-state drive 120 stores program instructions suitable for being loaded into the memory 130 and executed by the processor 110 for displaying information to a user of the computer system 100 as will be described in further detail below. For example, the program instructions may be part of a map or navigational application executable by the processor 110. The network module 140 and the GPS module 150 allow communication between different computer systems, servers and/or other devices.

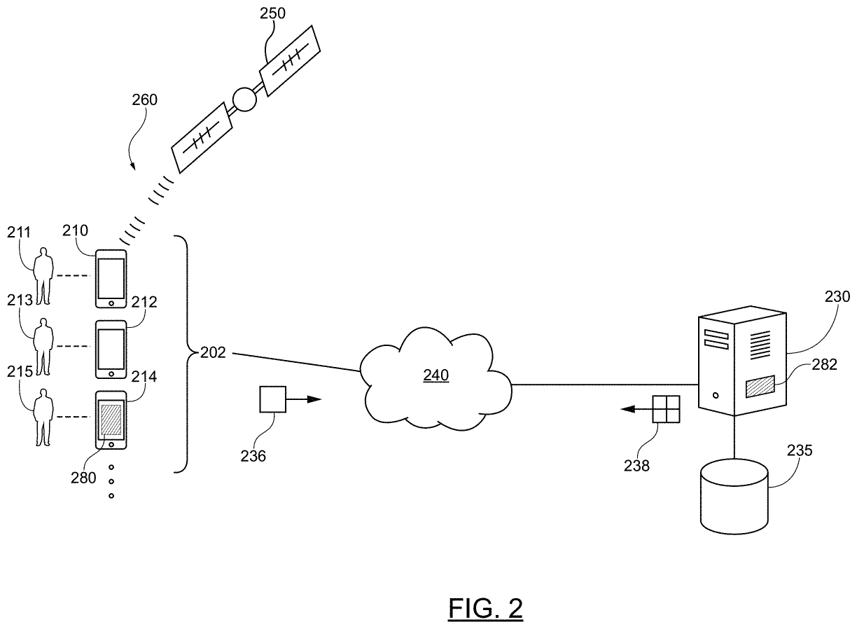

FIG. 2 illustrates a networked computing environment 200 suitable for use with some embodiments of the systems and/or methods of the present technology. The networked computing environment 200 comprises a plurality of electronic devices 202. The plurality of electronic devices 202 comprises electronic devices 210, 212 and 214 (individually referred to as a “navigational device”) respectively associated with users 211, 213 and 215 (individually referred to as a “user”). As it will be described herein below, each one of the users 211, 213, 215 may operate a respective vehicle (not depicted).

It should be noted that although the plurality of electronic devices 202 was depicted as comprising three distinct navigational devices, this may not and does not need to be the case in each and every implementation of the present technology. In fact, the plurality of electronic devices 202 may comprise a larger number of navigational devices such as 100, 1000, 10000, 1000000, and the like.

The networked computing environment 200 also comprises a server 230 in communication with the plurality of electronic devices 202 via a communications network 240 and a GPS satellite 250 transmitting and/or receiving a GPS signal 260 to/from the plurality of electronic devices 202. It will be understood that the present technology is not limited to GPS and may employ a positioning technology other than GPS (such as, GLONASS, etc.).

In some embodiments of the present technology, the communications network 240 is the Internet. In alternative non-limiting embodiments, the communication network can be implemented as any suitable local area network (LAN), wide area network (WAN), a private communication network or the like. It should be expressly understood that implementations for the communication network are for illustration purposes only. How a communication link (not separately numbered) between a given navigational device and the communications network 240 is implemented will depend inter alia on how the given navigational device is implemented.

In some embodiments of the present technology, the server 230 is implemented as a conventional computer server. In one non-limiting example, the server 230 is implemented as a Dell™ PowerEdge™ Server running the Microsoft™ Windows Server™ operating system, but can also be implemented in any other suitable hardware, software, and/or firmware, or a combination thereof. In the depicted non-limiting embodiments of the present technology, the server is a single server. In alternative non-limiting embodiments of the present technology (not shown), the functionality of the server 230 may be distributed and may be implemented via multiple servers.

The implementation of a given navigational device from the plurality of electronic devices 202 is not particularly limited, but as an example, the given navigational device may be implemented as a wireless communication device such as a mobile telephone (e.g. a smart phone or a radio-phone), a vehicle navigation device (e.g. TomTom™, Garmin™), a tablet, a personal computer and the like. However in FIG. 2, each given navigational device is depicted as the smart phone (although, they do not need to be implemented the same and a given one of the navigational devices may be implemented from another one of the navigational devices).

The given navigational device may comprise some or all of the components of the computer system 100 depicted in FIG. 1. In some embodiments, the given navigational device comprises the network module 140 for communicating with the server 230 via the communications network 240, the GPS module 150 for receiving and transmitting the GPS signal 260 to the GPS satellite 250 (i.e., for enabling GPS capabilities of the given navigational device), the processor 110, the memory 130, and a display interface such as a touch-screen for example. The given navigational device comprises hardware and/or software and/or firmware, or a combination thereof, for executing a map application, only one instance of which is depicted in FIG. 1 at 280 in association with the electronic device 214. In some embodiments of the present technology, the given navigational device may be configured to augment the GPS information using wireless-network mapping techniques that determine a geographic location based on the presence of certain wireless networks proximate to the user device (e.g., Wi-Fi mapping).

In a specific non-limiting embodiment of the present technology, the map application 280 may be implemented as Yandex.Maps™ or Yandex.Navigator™ applications made available by Yandex®.

The map application 280 is configured for a two-way communication with the server 230. The server 230 is configured to execute a server-side map application 282. The map application 280 and the server-side map application 282 are configured for delivering to the user (such as the user 215) map and route information. In some embodiments of the present technology, the map application 280 is configured to generate and to send to the server 230 a map request 236, the map request 236 containing information about map information requested by the user 215 (such as an address for depicting a particular point of interest or routing information for generating a route). The map request 236 can be generated in response to the user 215 interacting with the map application 280 (such as entering the requested info, etc.). In response to the receipt of the map request 236, the server 230 can generate and transmit to the map application 280 a map information packet 238, the map information packet 238 containing data required for the map application 280 to generate and display a map view that is responsive to the information requested by the user 215 and transmitted as part of the map request 236.

In alternative embodiments of the present technology, the map application 280 can store locally (i.e. on the electronic device 214) some map information for so-called offline browsing (i.e. generation of map information without having to send the map request 236 and/or to receive the map information packet 238). In other words and broadly speaking, the map application 280 can render the map application based on information received from the server 230 either in real time or in an offline manner.

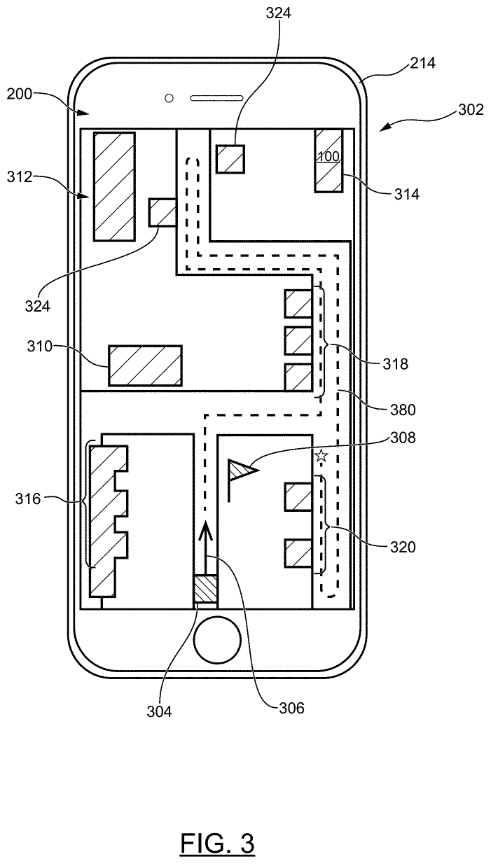

With reference to FIG. 3, there is depicted the electronic device 214 with an output of the map application 280. The map application 280 depicts an output (route information), which may have been generated based on the map information packet 238 received from the server 230. The map application 280 depicts a map view 302. The map view 302 includes an indication of a user vehicle 304 and an indication of a suggested route 306 (depicted as an “arrow”) towards a destination position 308, depicted as a flag.

It is assumed that the user 215 of the user vehicle 304 has requested route information and has followed the suggested route 306 and is almost at the destination position 308. The situation depicted in FIG. 3 is typical of when the user 215 has reached her destination and now needs to look for parking. Depicted in FIG. 3 is a set of possible parking spots, including a first parking garage 310, a second parking garage 312, a third parking garage 314, a first set if parking spots 316 (that includes three individual parking spots), a second set of parking spots 318 (that includes three individual parking spots), a third set of parking spots 320 (that includes two individual parking spots), a first individual parking spot 322 and a second individual parking spot 324. The set of possible parking spots (the first parking garage 310, the second parking garage 312, the third parking garage 314, the first set if parking spots 316, the second set of parking spots 318, the third set of parking spots 320, the first individual parking spot 322 and the second individual parking spot 324) represent all the potential parking spots where the user 215 may be able to park the user vehicle 304.

As has been alluded to above, during this first instance of time (which is very representative of what prior art map applications are capable of) do very little to suggest the possible parking spots to the user 215 (other than, for example, showing the presence of a potential parking spot or a number of total parking spots available at a given multi-spot parking garage, such as the third parking garage 314, for example).

Within this illustration, the user 215 has multiple choices. The user 215 may turn left (and then left again), in which case the user 215 may access and potentially find a parking spot at the one of: the first parking garage 310 or the first set if parking spots 316. Alternatively, the user 215 may turn right (and then right again), in which case the user 215 may access and potentially find a parking spot at the one of the third set if parking spots 320. Finally, the user 215 may turn right, then turn left, then left again, at which point the user 215 may turn right. Following this route, the user 215 may find a parking spot at one of (in this order): the second set of parking spots 318, the first individual parking spot 322, and the second individual parking spot 324, The user 215 may then turn left (using a road segment, which is not visible), in which case the user 215 may be able to access and find a parking spot at the second parking garage 312. By the same token, the user 215 may then turn right (using a road segment, which is not visible), in which case the user 215 may be able to access and find a parking spot at the third parking garage 314.

One may appreciate, that the illustration of FIG. 3 depicts a very simplistic version of a map and, therefore, in reality, the user 215 may end up wasting a considerable amount of time to drive around all the possible parking spots (the first parking garage 310, the second parking garage 312, the third parking garage 314, the first set if parking spots 316, the second set of parking spots 318, the third set of parking spots 320, the first individual parking spot 322 and the second individual parking spot 324) in a hope to find a free parking spot.

In accordance with the non-limiting embodiments of the present technology, the map application 280 is configured to display (and the server 230 is configured to generate for displaying by the map application 280) a parking route 380. As will be explained in greater detail herein below, the server 230 generates the parking route 380 such as to optimize the parking route 380 based on: a distance from the least some of the set of parking candidates to the destination position 308; total travel time through the parking route 380; a total parking probability that is based on the parking-spot-probability at each of at least of the set of parking candidates. Within this specific non-limiting illustration, the parking route 380 covers a subset of parking candidates spots (i.e. the second set of parking spots 318, the first individual parking spot 322, the second individual parking spot 324, the third set of parking spots 320) out of the totality of parking candidates possible within the view of the output of the map application 280 visible in FIG. 3 spots (i.e. the first parking garage 310, the second parking garage 312, the third parking garage 314, the first set if parking spots 316, the second set of parking spots 318, the third set of parking spots 320, the first individual parking spot 322 and the second individual parking spot 324).

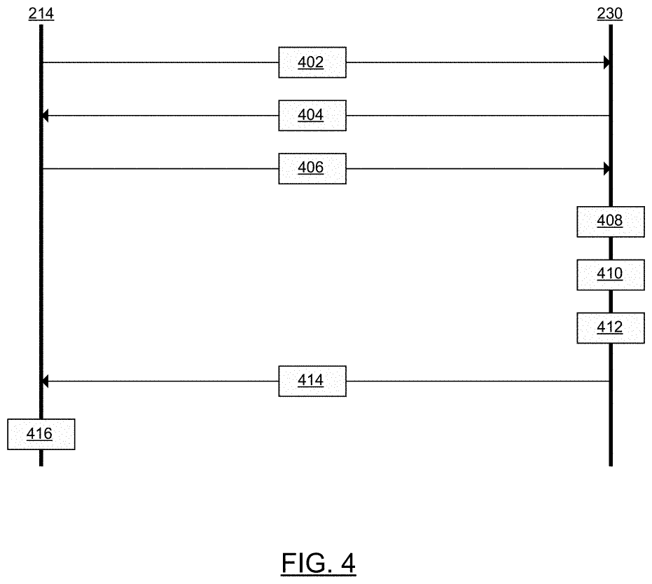

With reference to FIG. 4, there is depicted a signal flow diagram depicting signal flow between the electronic device 214 and the server 230, the signal flow being implemented in accordance with the non-limiting embodiments of the present technology.

Signal Flow 402

As part of signal flow 402, the electronic device 214 transmits to the server 230 a request for a route information.

In some embodiments of the present technology, the signal flow 402 may have been generated in response to the user 215 interacting with the map application 280. The exact implementation of the user interaction with the map application 280 is not particularly limiting. The user 215 may have entered a destination address and an origination address. Alternatively, the origination address may be determined using the GPS (or other capabilities) of the electronic device 214 (for example, by using the aforementioned GPS module 150).

In yet further possible implementations, the user 215 may have clicked or otherwise activated a link (from an e-mail message or a web site), which have automatically loaded the destination address into the map application 280.

Signal Flow 404

As part of the signal flow 404, the server 230 transmits the electronic device 214 information sufficient for the map application 280 to display to the user 215 the routing information between the requested start and end points.

As the user 215 to starts to drive along the route, the map application 280 constantly monitors the geo-position of the electronic device 214. For most map applications 280 this is an inherent function to enable the map application 280 to show to the user 215 the updated position of the user 215 as the user 215 progresses along the route.

Signal Flow 406

As part of the signal flow 406, the server 230 receives from the electronic device 214 an indication of a geo-position associated with the electronic device 214. In some embodiments of the present technology, the map application 280 generates the signal flow 406 as the electronic device 214 approaches the destination position within a pre-determined distance. For example, the electronic device 214 can generate the signal flow 406 as the electronic device 214 is within 300 meters of the destination point. Naturally, any other suitable value for the pre-determined distance can be selected by the operator of the computer system 100.

In alternative embodiments of the present technology, the value for the distance can be selected by the user 215 as part of setting preferences for the map application 280.

Signal Flow 408

As part of the signal flow 408, the server 230 generates, based on the geo-position of the electronic device 214, a set of parking candidates.

In some embodiments of the present technology, the server 230 generates, based on the geo-position of the electronic device 214, a set of parking candidates based solely on the geo-position of the electronic device. In these embodiments of the present technology, the set of parking candidates is selected from all possible parking spots such that the set of parking candidates is located within a pre-determined radius from the geo-position of the electronic device 214. The pre-determined radius can be any suitable value, such as within 200 meters, 500 meters, a kilometre and the like. Just like with the example above in relation to the pre-determined distance, this pre-determined radius can be set by the operator of the computer system 100 or as a user-preference by the user 215.

In other embodiments of the present technology, the server 230 generates the set of parking candidates based on both the distance from the least some of the set of parking candidates to the destination position 308 and the distance from the at least some of the set of parking candidates to the geo-position (i.e. the current location of the user 215).

Using the example provided above, the server generates the set of parking candidates out of all possible parking candidates—the first parking garage 310, the second parking garage 312, the third parking garage 314, the first set if parking spots 316, the second set of parking spots 318, the third set of parking spots 320, the first individual parking spot 322 and the second individual parking spot 324.

Signal Flow 410

As part of signal flow 410, the server 230 determines a parking-spot-probability at each of the set of parking candidates selected as part of the signal flow 408. In some embodiments of the present technology, the server 230 determines the parking-spot-probability using an algorithm disclosed in a co-owned patent application entitled “SYSTEM AND METHOD FOR DETERMINING PARKING AVAILABILITY”, filed with the Russian Patent Office (RosPatent) on Nov. 7, 2017 and bearing an application number 2017138515; the content of which is incorporated herein by reference in its entirety.

Briefly, in a specific non-limiting embodiment of the present technology, the server 230 may determine the parking-spot-probability based on a probability of the given parking spot being available P(parkᵢ), which may be considered dependent on the current demand for the parking space, availability, and its maximum capacity, as represented in Equation (1) below:

P(parkᵢ)≈∝·f_{cool}(parkᵢ)=∝·f_{cool}(demandᵢ,availabilityᵢ,capacityᵢ) (1)

wherein f_{cool} is a function for determining specific probability and may vary for different cities. For example, for a first city (e.g., Moscow) and parking spaces in the streets, f_{cool} may be a first probability function depicting linear parking places in the streets, while for a second city (e.g., Los Angeles) and respectively mall parking places with hundreds parking spaces per each parking lot, a second probability function may be applied. In some implementation, the first probability function may be a cumulative distribution function, and a second probability function may be a probability mass function. In some aspects, each probability function use a set of factors such as a multivariate random variable, or random vector.

Signal Flow 412

As part of the signal flow 412, the server 230 generates the parking route 380 such as to optimize the parking route 380 based on: a distance from the least some of the set of parking candidates to the destination position 308; total travel time through the parking route 380; a total parking probability that is based on the parking-spot-probability at each of at least of the set of parking candidates.

In some embodiments of the present technology, the server 230 optimizes the parking route 380 such that: (i) to minimize the distance from a given one of the least some of the set of parking candidates to the destination position, the given one being an actual parking location where the user 215 may end up parking; and (ii) to minimize the total travel time through the so-recommended parking route 380. It is noted that the total travel time is the travel time from the current location to the actual parking location and the total travel time is for travelling through a portion of the parking route from the current position and the actual parking location.

Now, we will turn out attention to the various non-limiting example, how the server 230 can implement the step of generating the parking route 380.

In a specific non-limiting example, the optimization of the parking route 380 can be executed by applying, by the server 230, a Pareto optimality (or efficiency) algorithm. As is known to those of skill in the art, Pareto efficiency is a state of allocation of resources from which it is impossible to reallocate so as to make any one individual or preference criterion better off without making at least one individual or preference criterion worse off.

In some embodiments of the present technology. The server 230 generates the optimization of the parking route 380 by, for a given one of the set of parking candidates: (i) determining a distance from the current location to the given one of the set of parking candidates; and (ii) determining a single-state optimization value, the single-state optimization value based on the probability to park at the given one of the set of parking candidates, the single-state optimization value being representative of: (a) the distance from the given one of the set of parking candidates to the destination position; (b) the total travel time through the parking route from the current location to the given one of the set of parking candidates; and the total parking probability that is based on the parking-spot-probability at the given one of the set of parking candidates.

Once the single-state optimization value is determined, the server 230 generates the optimization of the parking route 380 by further: determining a two-state optimization value, the two-state optimization value based on the probability to park at a next sequential one following the given one of the set of parking candidates, the two-state optimization value being representative of: the distance from the next sequential one of the set of parking candidates to the destination position; the total travel time through the parking route from the current location to next sequential one; the total parking probability that is based on the parking-spot-probability at the given one of the set of parking candidates and the next sequential one.

The server 230 then repeats the process for all other parking candidates. In other words, it can be said that the server 230 executes repeating the determining step of an N-th-state optimization values using a N-next sequential ones following the next sequential one following the given one of the set of parking candidates. In some non-limiting embodiments of the present technology, the server 230 further executes repeating the determining process for all of the set of parking candidates.

Therefore, it can be said that in some embodiments of the present technology, the server 230 can further execute repeating the determining process for all of the set of parking candidates is executed iteratively for all of the set of parking candidates, whereby the iterative process involves starting with a given one and growing a chain of candidates to an N-th length of the at least some of the set of parking candidates.

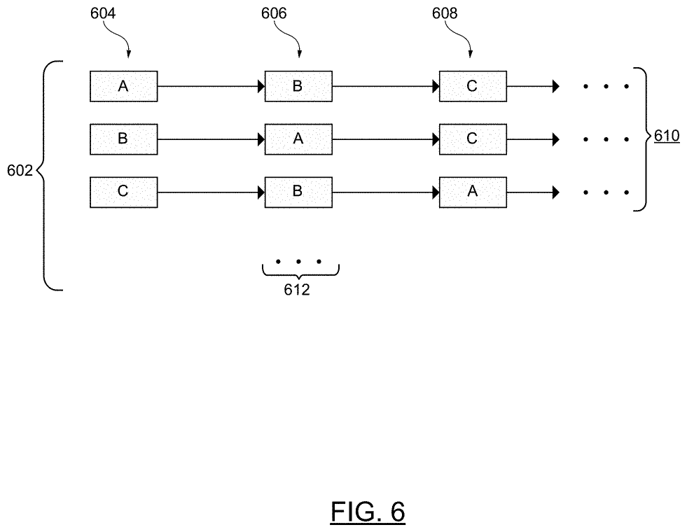

This process is best demonstrated using a schematic illustration of FIG. 6, which schematically depicts a process 602 for growing the chain of candidates to an N-th length of the at least some of the set of parking candidates. Within the illustration of FIG. 6, for the purposes of simplicity only, only three iterations are depicted—a first iteration 604, a second iteration 606, and a third iteration 608. However, it should be expressly understood that a number of additional iterations are possible (collectively depicted at 610), until the chain having the N-th length is developed.

At the first iteration 604, the server 230 for a given one of the set of parking candidates determines a single-state optimization value, the single-state optimization value based on the probability to park at the given one of the set of parking candidates, the single-state optimization value being representative of: (a) the distance from the given one of the set of parking candidates to the destination position; (b) the total travel time through the parking route from the current location to the given one of the set of parking candidates; and (iii) the total parking probability that is based on the parking-spot-probability at the given one of the set of parking candidates.

As illustrated in FIG. 6, the server 230 generates the single-state optimization value for each one of the parking candidates—A, B, and C (as well as any other additional parking candidates, jointly depicted at 612).

At the second iteration 606, the server 230 determines a two-state optimization value, the two-state optimization value based on the probability to park at a next sequential one following the given one of the set of parking candidates, the two-state optimization value being representative of: the distance from the next sequential one of the set of parking candidates to the destination position; the total travel time through the parking route from the current location to next sequential one; the total parking probability that is based on the parking-spot-probability at the given one of the set of parking candidates and the next sequential one.

As illustrated in FIG. 6, the two state-optimization values are generated for A-->B, B-->A, and C-->B two candidate states (as well as other potential two candidate states, which are jointly depicted at 612).

At iteration 608, the server 230 determines a three-state optimization value, the three-state optimization value based on the probability to park at a next sequential one following the given one of the set of parking candidates, the three-state optimization value being representative of: the distance from the next sequential one of the set of parking candidates to the destination position; the total travel time through the parking route from the current location to next sequential one; the total parking probability that is based on the parking-spot-probability at the given one of the set of parking candidates and the next sequential one.

As illustrated in FIG. 6, the three state-optimization values are generated for A-->B-->C, B-->A-->C, and C-->B-->A three candidate states (as well as other potential three candidate states, which are jointly depicted at 612).

As has been previously alluded to, the server 230 repeats the process—i.e. repeating the determining process for all of the set of parking candidates is executed iteratively for all of the set of parking candidates, whereby the iterative process involves starting with a given one and growing a chain of candidates to an N-th length of the at least some of the set of parking candidates (as depicted at 610).

Recalling that the server 230 can execute the Pareto-based optimization, in some embodiments of the present technology, the server 230 can further execute pruning the N-th-state optimization values that have both the total travel time and the distance being under a pre-determined respective threshold value. In other words, instead of processing all the possible combinations of the routes, the server 230 can further optimize the process by dynamically discarding certain of the generated parking routes that are apriori not suitable, such as for example, those where the travel time and/or the distance are below the pre-determined acceptability threshold.

In some embodiments of the present technology, the server 230 can further execute selecting the at least some of the set of parking candidates from the set of parking candidates based on the N-th-state optimization values that are associated with the total parking probability above a pre-determined threshold value.

The process can further include: based on a minimal value of an average distance to the destination position, the average distance being a contribution to a total distance value of each individual distances of members of a group associated with a particular state of the N-th-state optimization values.

In some embodiments of the present technology, the server 230 can further execute calculating the total parking probability as a sum of the parking-spot-probability at the given one of the set of parking candidates and the parking-spot-probability at the next sequential one.

Signal Flow 414

As part of the signal flow 414, the server 230 transmits an indication of the parking route 380 to the electronic device 214 the signal flow 414 for enabling the electronic device 214 to display the parking route 380 to the user.

Signal Flow 416

As part of the signal flow 416, the map application 280 depicts, within the map view 302, the indication of the parking route 380. It is noted that the matter for displaying the parking route 380 (i.e. visual characteristics thereof) is not particularly limiting and various specific non-limiting embodiments are contemplated.

In some non-limiting embodiments of the present technology, it is contemplated that the visual presentation of the parking route 380 can be different from the suggested route 306. For example, the suggested route 306 can be depicted in a solid line and the parking route 380 can be depicted in a dotted line. Alternatively or additionally, the suggested route 306 can be depicted in a first color and the parking route 380 can be depicted in a second color. Within these embodiments of the present technology, the different visual depiction of the suggested route 306 and the parking route 380 allows for the user 215 to easily and conveniently distinguish between the two.

However, in alternative non-limiting embodiments of the present technology, the parking route 380 can be depicted in the same visual manner as the suggested route 306.

The Method Description

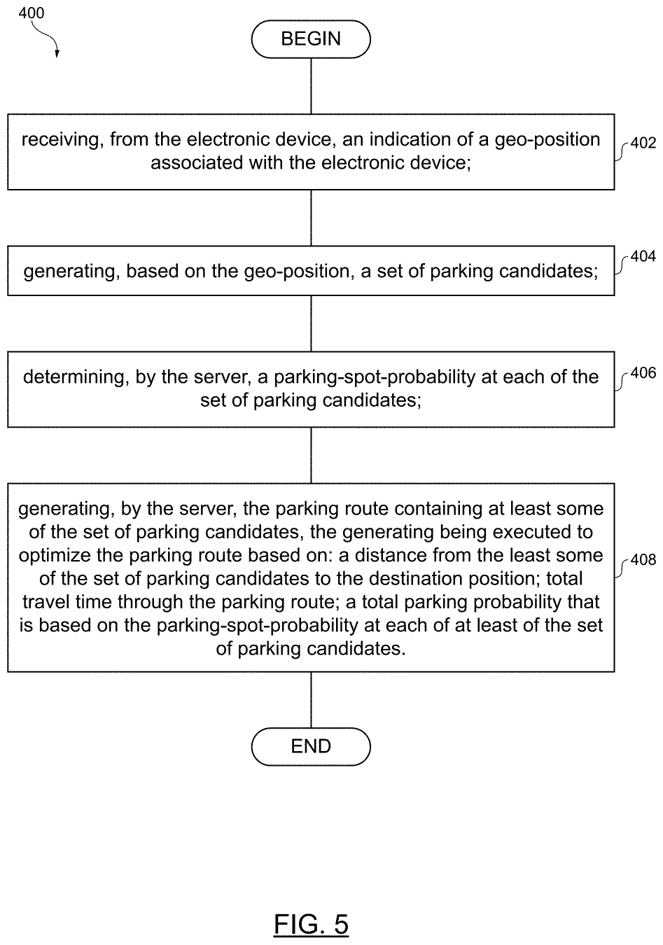

Given the architecture described above, it is possible to execute a method of generating the parking route 380, the parking route is to be displayed in the map application 280, the map application 280 executable by the electronic device 214 (which is connectable to a server 230 via the communications network 240). With reference to FIG. 5, there is depicted a flow chart of a method 500, the method 500 executable by the server 230.

Step 502—receiving, from the electronic device, an indication of a geo-position associated with the electronic device

At step 502, the server 230 receives, from the electronic device 214, an indication of a geo-position associated with the electronic device 214.

As has been alluded to above with reference to the signal flow 406, the server 230 receives from the electronic device 214 an indication of a geo-position associated with the electronic device 214. In some embodiments of the present technology, the map application 280 generates the signal flow 406 as the electronic device 214 approaches the destination position within a pre-determined distance. For example, the electronic device 214 can generate the signal flow 406 as the electronic device 214 is within 300 meters of the destination point. Naturally, any other suitable value for the pre-determined distance can be selected by the operator of the computer system 100.

In alternative embodiments of the present technology, the value for the distance can be selected by the user 215 as part of setting preferences for the map application 280.

Step 504—generating, based on the geo-position, a set of parking candidates

At step 504, the server 230 generates, based on the geo-position, a set of parking candidates. As has been alluded to above with reference to the signal flow 408, the server 230 generates, based on the geo-position of the electronic device 214, a set of parking candidates.

In some embodiments of the present technology, the server 230 generates, based on the geo-position of the electronic device 214, a set of parking candidates based solely on the geo-position of the electronic device. In these embodiments of the present technology, the set of parking candidates is selected from all possible parking spots such that the set of parking candidates is located within a pre-determined radius from the geo-position of the electronic device 214. The pre-determined radius can be any suitable value, such as within 200 meters, 500 meters, a kilometre and the like. Just like with the example above in relation to the pre-determined distance, this pre-determined radius can be set by the operator of the computer system 100 or as a user-preference by the user 215.

In other embodiments of the present technology, the server 230 generates the set of parking candidates based on both the distance from the least some of the set of parking candidates to the destination position 308 and the distance from the at least some of the set of parking candidates to the geo-position (i.e. the current location of the user 215).

Using the example provided above, the server generates the set of parking candidates out of all possible parking candidates—the first parking garage 310, the second parking garage 312, the third parking garage 314, the first set if parking spots 316, the second set of parking spots 318, the third set of parking spots 320, the first individual parking spot 322 and the second individual parking spot 324.

Step 506—determining, by the server, a parking-spot-probability at each of the set of parking candidates

At step 506, the server 230 determines a parking-spot-probability at each of the set of parking candidates. As has been described above with reference to the signal flow 410, the server 230 determines a parking-spot-probability at each of the set of parking candidates selected as part of the signal flow 408. In some embodiments of the present technology, the server 230 determines the parking-spot-probability using an algorithm disclosed in a co-owned patent application entitled “SYSTEM AND METHOD FOR DETERMINING PARKING AVAILABILITY”, filed with the Russian Patent Office (RosPatent) on Nov. 7, 2017 and bearing an application number 2017138515; the content of which is incorporated herein by reference in its entirety.

Briefly, in a specific non-limiting embodiment of the present technology, the server 230 may determine the parking-spot-probability based on a probability of the given parking spot being available P(parkᵢ), which may be considered dependent on the current demand for the parking space, availability, and its maximum capacity, as represented in Equation (1) below:

P(parkᵢ)≈∝·f_{cool}(parkᵢ)=∝·f_{cool}(demandᵢ,availabilityᵢ,capacityᵢ) (1)

wherein f_{cool} is a function for determining specific probability and may vary for different cities. For example, for a first city (e.g., Moscow) and parking spaces in the streets, f_{cool} may be a first probability function depicting linear parking places in the streets, while for a second city (e.g., Los Angeles) and respectively mall parking places with hundreds parking spaces per each parking lot, a second probability function may be applied. In some implementation, the first probability function may be a cumulative distribution function, and a second probability function may be a probability mass function. In some aspects, each probability function use a set of factors such as a multivariate random variable, or random vector.

Step 508—generating, by the server, the parking route containing at least some of the set of parking candidates, the generating being executed to optimize the parking route based on: a distance from the least some of the set of parking candidates to the destination position; total travel time through the parking route; a total parking probability that is based on the parking-spot-probability at each of at least of the set of parking candidates.

At step 508, the server 230 generates the parking route 380 containing at least some of the set of parking candidates, the generating being executed to optimize the parking route based on: a distance from the least some of the set of parking candidates to the destination position; total travel time through the parking route; a total parking probability that is based on the parking-spot-probability at each of at least of the set of parking candidates.

As has been described above with reference to the signal flow 412, the server 230 generates the parking route 380 such as to optimize the parking route 380 based on: a distance from the least some of the set of parking candidates to the destination position 308; total travel time through the parking route 380; a total parking probability that is based on the parking-spot-probability at each of at least of the set of parking candidates.

In some embodiments of the present technology, the server 230 optimizes the parking route 380 such that: (i) to minimize the distance from a given one of the least some of the set of parking candidates to the destination position, the given one being an actual parking location where the user 215 may end up parking; and (ii) to minimize the total travel time through the so-recommended parking route 380. It is noted that the total travel time is the travel time from the current location to the actual parking location and the total travel time is for travelling through a portion of the parking route from the current position and the actual parking location.

Now, we will turn out attention to the various non-limiting example, how the server 230 can implement the step of generating the parking route 380.

In a specific non-limiting example, the optimization of the parking route 380 can be executed by applying, by the server 230, a Pareto optimality (or efficiency) algorithm. As is known to those of skill in the art, Pareto efficiency is a state of allocation of resources from which it is impossible to reallocate so as to make any one individual or preference criterion better off without making at least one individual or preference criterion worse off.

In some embodiments of the present technology. The server 230 generates the optimization of the parking route 380 by, for a given one of the set of parking candidates: (i) determining a distance from the current location to the given one of the set of parking candidates; and (ii) determining a single-state optimization value, the single-state optimization value based on the probability to park at the given one of the set of parking candidates, the single-state optimization value being representative of: (a) the distance from the given one of the set of parking candidates to the destination position; (b) the total travel time through the parking route from the current location to the given one of the set of parking candidates; and the total parking probability that is based on the parking-spot-probability at the given one of the set of parking candidates.

Once the single-state optimization value is determined, the server 230 generates the optimization of the parking route 380 by further: determining a two-state optimization value, the two-state optimization value based on the probability to park at a next sequential one following the given one of the set of parking candidates, the two-state optimization value being representative of: the distance from the next sequential one of the set of parking candidates to the destination position; the total travel time through the parking route from the current location to next sequential one; the total parking probability that is based on the parking-spot-probability at the given one of the set of parking candidates and the next sequential one.

The server 230 then repeats the process for all other parking candidates. In other words, it can be said that the server 230 executes repeating the determining step of an N-th-state optimization values using a N-next sequential ones following the next sequential one following the given one of the set of parking candidates. In some non-limiting embodiments of the present technology, the server 230 further executes repeating the determining process for all of the set of parking candidates.

Therefore, it can be said that in some embodiments of the present technology, the server 230 can further execute repeating the determining process for all of the set of parking candidates is executed iteratively for all of the set of parking candidates, whereby the iterative process involves starting with a given one and growing a chain of candidates to an N-th length of the at least some of the set of parking candidates.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A method of generating a parking route to a destination position, the parking route to be displayed in a map application, the map application executable by an electronic device, the electronic device connectable to a server via a communication network, the method executable by the server, the method comprising:
receiving, from the electronic device, an indication of a geo-position associated with the electronic device;
generating, based on the geo-position, a set of parking candidates;
determining, by the server, a parking-spot-probability at each of the set of parking candidates;
generating, by the server, the parking route containing at least some of the set of parking candidates, the generating being executed to optimize the parking route based on:
a distance from the least some of the set of parking candidates to the destination position;
total travel time through the parking route;
a total parking probability that is based on the parking-spot-probability at each of at least of the set of parking candidates.

2. The method of claim 1, wherein the geo-position includes a current position of the electronic device and an indication of the destination position, and wherein the generating the set of parking candidates comprises generating the set of parking candidates such that:
each of the set of parking candidates located within a pre-determined radius from at least one of: the current position and the destination position.

3. The method of claim 2, wherein the generating the parking route is executed such as to:
minimize the distance from a given one of the least some of the set of parking candidates to the destination position, the given one being an actual parking location;
minimize the total travel time.

4. The method of claim 3, wherein the total travel time is the travel time from the current location to the actual parking location.

5. The method of claim 1, wherein optimizing the parking route comprises applying a Pareto optimality algorithm.

6. The method of claim 2, wherein the generating the parking route comprises, for a given one of the set of parking candidates:
determining a distance from the current location to the given one of the set of parking candidates;
determining a single-state optimization value, the single-state optimization value based on the probability to park at the given one of the set of parking candidates, the single-state optimization value being representative of:
the distance from the given one of the set of parking candidates to the destination position;
the total travel time through the parking route from the current location to the given one of the set of parking candidates;
the total parking probability that is based on the parking-spot-probability at the given one of the set of parking candidates.

7. The method of claim 6, wherein the generating the parking route, for the given one of the set of parking candidates, further comprises:
determining a two-state optimization value, the two-state optimization value based on the probability to park at a next sequential one following the given one of the set of parking candidates, the two-state optimization value being representative of:
the distance from the next sequential one of the set of parking candidates to the destination position;
the total travel time through the parking route from the current location to next sequential one;
the total parking probability that is based on the parking-spot-probability at the given one of the set of parking candidates and the next sequential one.

8. The method of claim 6, the method further comprising repeating the determining step of an N-th-state optimization values using a N-next sequential ones following the next sequential one following the given one of the set of parking candidates.

9. The method of claim 8, the method further comprising repeating the determining process for all of the set of parking candidates.

10. The method of claim 9, the method further comprising pruning the N-th-state optimization values that have both the total travel time and the distance being under a pre-determined respective threshold value.

11. The method of claim 9, the method further comprising:
selecting the at least some of the set of parking candidates from the set of parking candidates based on the N-th-state optimization values that are associated with the total parking probability above a pre-determined threshold value.

12. The method of claim 11, wherein the selecting the at least some of the set of parking candidates from the set of parking candidates further comprises:
based on a minimal value of an average distance to the destination position, the average distance being a contribution to a total distance value of each individual distances of members of a group associated with a particular state of the N-th-state optimization values.

13. The method of claim 7, wherein the method further comprises:
calculating the total parking probability as a sum of the parking-spot-probability at the given one of the set of parking candidates and the parking-spot-probability at the next sequential one.

14. The method of claim 8, wherein the repeating the determining process for all of the set of parking candidates is executed iteratively for all of the set of parking candidates, whereby the iterative process involves starting with a given one and growing a chain of candidates to an N-th length of the at least some of the set of parking candidates.

15. The method of claim 2, wherein the method further comprises retrieving the destination position from the map application.

16. A server configured to generate a parking route, the vehicle route to be displayed in a map application, the map application executable by an electronic device, the electronic device connectable to the server via a communication network, the server comprising:
a network interface for communication via the communication network;
a processor coupled to the network interface, the processor configured to:
receive, from the electronic device, an indication of a geo-position associated with the electronic device;
generate, based on the geo-position, a set of parking candidates;
determine, by the server, a parking-spot-probability at each of the set of parking candidates;
generate, by the server, the parking route containing at least some of the set of parking candidates, the generating being executed to optimize the parking route based on:
a distance from the least some of the set of parking candidates to the destination position;
total travel time through the parking route;
a total parking probability that is based on the parking-spot-probability at each of at least of the set of parking candidates.
